(19) United States
(12) Patent Application Publication
(10) Pub. No.: US 2011/0163023 A1
(43) Pub. Date: Jul. 7, 2011

(54) DEVICE FOR THE EQUILIBRIUM DIALYSIS OF FLUIDS

(75) Inventors: Stefan Kreusch, Golmsdorf (DE); Robert Fleischhauer, Erfurt (DE); Maximilian Bauer, Weimar (DE); Carlotta Werner, Weimar (DE)

(73) Assignee: SCIENOVA GMBH, Jena (DE)

(21) Appl. No.: 12/936,122

(22) PCT Filed: Apr. 1, 2009
(86) PCT No.: PCT/DE09/00427

§ 371 Date: Feb. 7, 2011

(30) Foreign Application Priority Data
Apr. 1, 2008 (DE) DE102008017083.6

(51) Int. Cl. B01D 61/28; B01D 61/18

(52) U.S. Cl. 210/232; 210/321.72; 210/321.73; 210/253

(57) ABSTRACT

The invention relates to a device for the equilibrium dialysis of fluids having small volumes. The object of the invention of creating a device for equilibrium dialysis , the device being designed as a simple as possible, being universally usable and reliable in the use thereof, with which a large ratio of the membrane surface to the sample volume is created and which facilitates very short diffusion paths inside the sample as well as low sample losses, even with small sample volumes, is achieved in that a device is proposed, which comprises corresponding capillaries (1, 1′), which are connected through a membrane (2) and each are open at the ends on both sides, said capillaries for dialysis purposes each comprising a preferably substantially U-shaped arched capillary portion, and the at least one opening (4, 4′) thereof being provided each with a sealing element for introducing and/or removing the liquid.

The invention relates to a device which is compatible to the micro-titer plate format for liquid handling technology for simple, reliable and quick parallel performing of equilibrium dialyses in containers with small volumes of 1 to 300 μl capacity. The device is preferably configured for single use, which helps with low cost production without the invention being limited thereto.

Equilibrium dialyses are preferably used for studying interactions of molecules with different sizes, e.g. of DNS or RNS with proteins and/or active substances, of active substances with soluble proteins, ligands with receptors. For this purpose, two liquid samples are placed into sample containers separated by a semi-permeable membrane and dialyzed until the concentration of the permeating molecules is approximately balanced. The velocity is a function of the concentration gradient between the samples, of the temperature, of the diffusion path and of the active surface and of the type of the semi-permeable membrane. The concentration gradient, the type of membrane and the temperature are typically predetermined by the application. A particularly large field of application is the field of ADME, in which the binding properties of potentially pharmaceutically usable active substances at plasma-, serum- and blood components is tested. This application mostly requires large numbers of samples. Thus, devices are desirable which have high dialysis speed, require small sample volumes, minimize sample losses and can be treated conveniently in parallel with automatable liquid handling technology. An important present standard of liquid handling technology relates to micro-titer plate formats according to ANSI SBS.

In order to satisfy these requirements in the best way possible, solutions have already been proposed, which facilitate sample treatment in micro-titer plate format.

Thus, a device by Harvard Apparatus (U.S. Pat. No. 6,458,275 B1) is known, which respectively includes two micro-titer plate elements, which are connected to one another in the base portion and whose sample volumes are separated from one another through a horizontal membrane in the base portion. The sample containers are closed by sealing mats, which are clamped in a rotating device and thus moved.

This solution can be handled manually and partially also with automated liquid handling technology.

The limited surface of the dialysis membrane is disadvantageous, wherein the limited surface provides a rather small ratio of membrane surface to sample volume, and is directly proportional to the particle transport through the membrane. An obstacle for automation is the necessity to fill two opposite sample volumes, since herein the device has to be closed tight after one side is filled and has to be rotated by 180 degrees in order to feed the other side. Thereafter, the dialysis device has to be manually attached in a rotating device. After the dialysis has been performed, respective processes which are not suitable for automation either occur in reverse sequence for extracting liquids. A complete extraction of the sample volume is hardly possible with typical multiple pipettes, since it is known that extracting samples from comparable micro-titer plates with flat bottoms also causes losses.

A device is also known in which the sample volumes of a cast micro-titer plate block are vertically divided by a semi permeable membrane and which includes openings for both sample volumes in an upper portion (U.S. Pat. No. 0215,538 A1).

Again the limited surface of the dialysis membrane is a disadvantage which provides a relatively small ratio of membrane surface to sample volume and which is directly proportional to the particle transport through the membrane. Also for this solution sample losses have to be expected during sample extraction. The expected complexity for safely attaching the semi permeable membrane in the containers appears rather high and is disadvantageous for the postulated use as a single use disposable device.

It is also known to assemble single preformed Teflon strips in an alternating manner with membranes in a retaining device and to seal them through pressure (U.S. Pat. No. 6,766,908 B1). The sample volumes in the micro-titer plate grid are respectively divided by the membrane through which the dialysis is performed. After dialysis a manual disassembly and cleaning of the device is performed.

Also here the closely limited surface of the dialysis membrane and the high complexity for pre and post treatment are disadvantages. The device introduced at http://htdialvsis.com does not comply with the dimensions from ANSI SBS Standard for automation and thus cannot be integrated into an automated system without additional complexity.

Furthermore Linden BScience (www.piercenet.com) offers a device which includes 48 inserts for performing dialysis in micro-titer plate format. The complexity for handling is rather high since the device also has to be assembled manually and has to be disassembled and cleaned after use.

Thus it is the object of the invention to provide a device for equilibrium dialysis which is universally useable and can be handled in a reliable manner and which provides a high ratio of membrane surface to sample volume and which facilities very short is diffusions paths within the sample and low sample losses also for small sample volumes.

The device shall be producible in a simple manner and for automation purposes of the dialysis it shall be compatible with present standards of liquid technique and shall facilitate handling large and also small numbers of samples. Furthermore at least high expenses for assembly, disassembly and recycling shall become redundant.

According to the invention the object is achieved by a device for the dialysis of liquids including corresponding opposed and aligned capillaries which are connected through a membrane and which are respectively open at both ends and which include respectively essentially U-shaped curved capillary portions for performing dialysis and whose at least one opening is provided with a respective seal element for introducing and/or removing the liquid.

Advantageous embodiments of the device are recited in the dependent claims.

The features of the invention provide respective pairs of corresponding curved, opposed and aligned capillaries which are integrated as recesses in housing components and which are assembled with a membrane placed between them and which are assembled with the membranes to form a dialysis system. This way single Dialysis modules (only a single pair of corresponding capillaries) or also entire dialysis systems (several or a plurality of pairs of respectively corresponding capillaries) can be implemented with little complexity.

The proposed capillary system which can thus be produced in a simple manner and which can be loaded or unloaded in a simple manner provides a dialysis cell which has a surprisingly large volume of membrane surface to sample volume, which furthermore can also be increased through additional curvature of the capillary paths (e.g. meander, zigzag or actuated). Furthermore very short diffusions paths within a sample are implemented through the configuration of the capillaries (c.f. also dependent claims).

Integrating the capillaries directly into the housing components facilitates good implementation for seal elements (e.g. cone shaped configuration of the at least one opening for introducing and/or removing liquid or using seal elements, e.g. seal mats or seal rings). Also sealing the housing components with the membrane placed there between which can be supported by gluing, welding, pressing etc. is without problems, which has been verified through own experiments. Housing surfaces which contact one another outside of the membrane surface are also connected tight with one another through pressure, gluing or welding. Thus, overall also only small sample losses can be provided which is very important for small sample volumes.

The capillaries can be provided with different cross sectional shapes (e.g. semi circular, rectangular, square, triangular, circular segment shaped) and extend in the portion which is used for sample dialysis essentially U-shaped with downward curvature. The maximum distance of the capillary wall from the membrane is below 4.5 mm, preferably below 1.5 mm.

It is advantageously possible to provide 8 or 12 such pairs of respectively corresponding capillaries (dialysis cells) adjacent to one another in a bar shaped module, wherein the openings for feeding and/or removing liquid are respectively routed upward and supported at a distance from one another which corresponds with the liquid handling technique. The dialysis cells disposed adjacent to one another which can thus be simultaneously filled or emptied through available 8-fold or 12-fold pipettes are respectively advantageously united through a single common semi permeable and e.g. comb shaped membrane by joining the housing components of the bar shaped modules liquid tight by placing said membrane there between. The housing components in which the capillaries are respectively configured as recesses in a plane can be produced e.g. through forming, machining, injection molding from metal, glass, plastic material or silicone with low complexity and through known and relatively simple process technologies.

Plural or multiple bar shaped modules which are universally useable can be assembled into a three dimensional dialysis unit in a compact manner, wherein the particular bar shaped modules are mechanically disengage able (e.g. through plugging clamping etc.) or permanently connected (e.g. through gluing, welding, riveting, etc.) or through receiving them on a base element like e.g. a base plate or a tub shaped container. For this purpose the bar shaped modules preferably include support or attachment elements in their base portion like e.g. pedestal or clamping elements and/or spring loaded elements for snap in type connections. The support and attachment elements can also be configured as rises above the base in a round, conical, rectangular or square shape.

The dialysis cell matrix assembled from bar shaped modules can be filled, transported and stored in easy and safe manner. Its openings for introducing and/or removing liquid are preferably compatible to the grid of known micro-titer plates and are subject to the SBS-Standard ANSI/SBS 1-2004. This way, automating the dialysis including preparation, performing and post processing the dialysis is even possible for a multitude of particular dialysis containers which provide very good handling for the dialysis device and the method without having to bring the device into a respective particular position e.g. through rotation when introducing or removing liquid. The device according to the invention can be filled in its entirety with the shortest method steps possible with a conventional pipette system and can be emptied again.

The modular configuration of the dialysis unit even facilitates providing application specific systems to users with respect to number and arrangement of the particular dialysis cells. Furthermore the already described low complexity production of the single joinable dialysis modules is facilitated, so that the modules are primarily efficient for single use and thus compared to the known devices recited supra, complex and expensive cleaning and possibly drying steps can be omitted.

The capillary system of a dialysis cell can be implemented, so that one capillary end respectively is run out of the housing formed by the housing components in upward direction for introducing and/or removing liquid. The opposite capillary end is run outward as a vent opening outside of the dialysis portion of the capillary preferably on the outside of the housing.

In another embodiment the capillary end opposite to the opening for feeding the liquid is configured as an outlet channel for removing liquid or as a vent channel extended in downward direction outside of the dialysis portion, so that the capillary overall is essentially S-shaped beyond the U-shaped portion used for dialysis. Through pressing air into the filling opening the outlet channel can also be used for dispensing samples besides being used for venting. Advantageously the outlet channel extending in downward direction terminates in an outlet element protruding towards the base of the housing component e.g. a protruding outlet tube, so that the liquid to be removed cannot run at the housing base in order to prevent sample losses and e.g. mixing of samples.

The invention is subsequently described with reference to embodiments depicted in drawing figures, wherein:

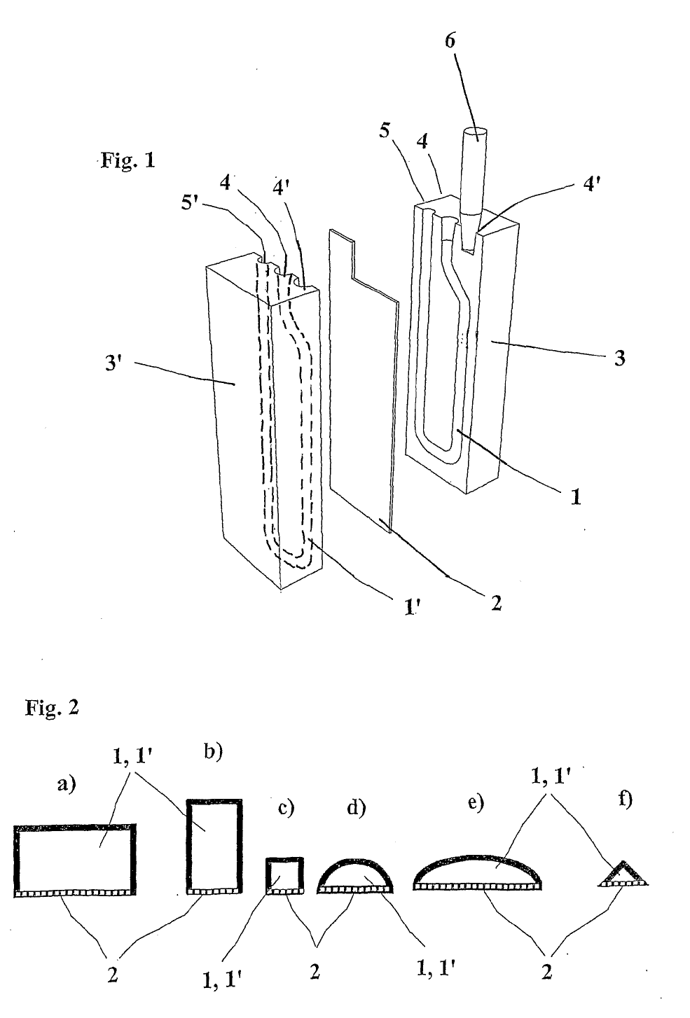

FIG. 1 illustrates a schematic view of a capillary unit (pair of corresponding and opposed and aligned capillaries which are connected through a membrane and which are open respectively at both ends);

FIG. 2 illustrates a schematic view of capillaries with different cross sectional shapes;

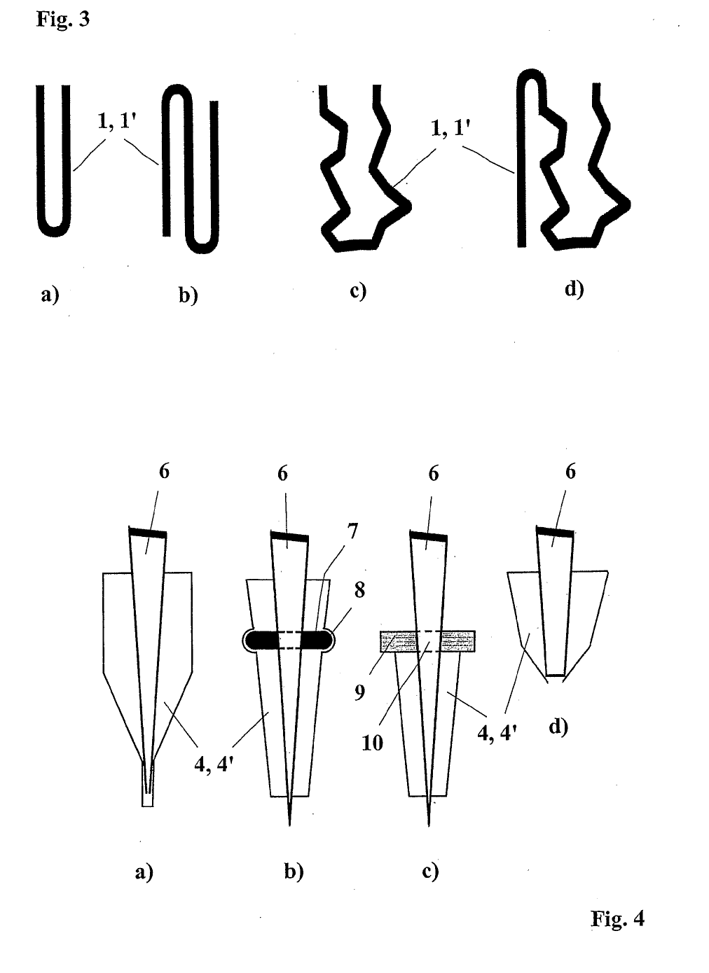

FIG. 3 illustrates a schematic view of different special paths of a capillary of a capillary unit;

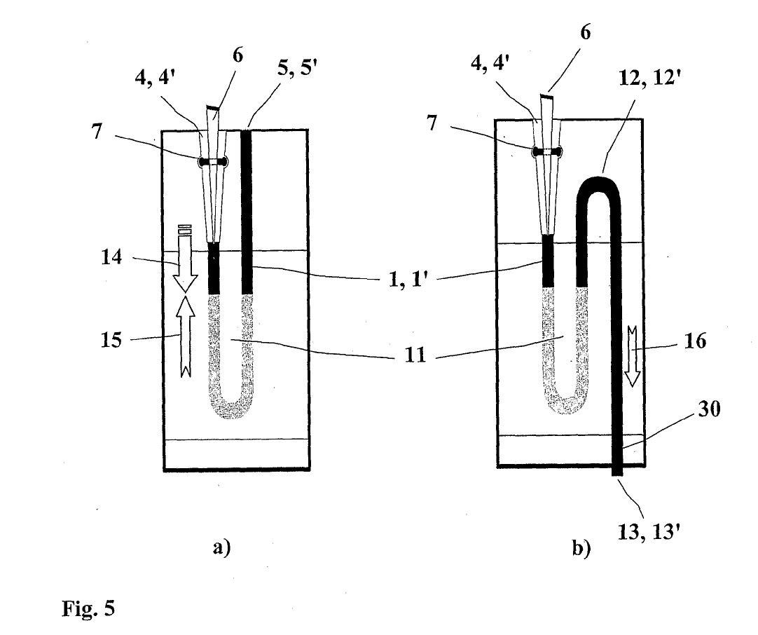

FIG. 4 illustrates a schematic view with different seal configurations of an opening for introducing and/or removing into/from the capillary through a pipette element;

FIG. 5 illustrates a schematic view of the paths of a capillary with both openings configured in upward direction (FIG. 5a) or run out of an opening in downward direction (FIG. 5b);

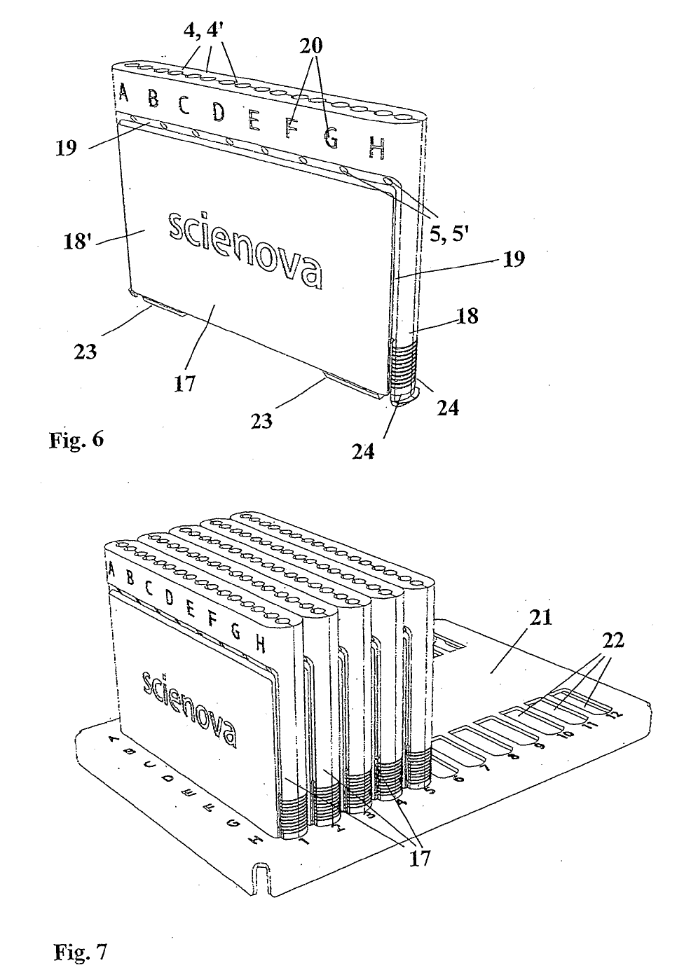

FIG. 6 illustrates a 8-fold dialysis module (bar shaped module with 8 pairs of respectively corresponding, aligned and opposed capillaries), including two housing components with a membrane place there between;

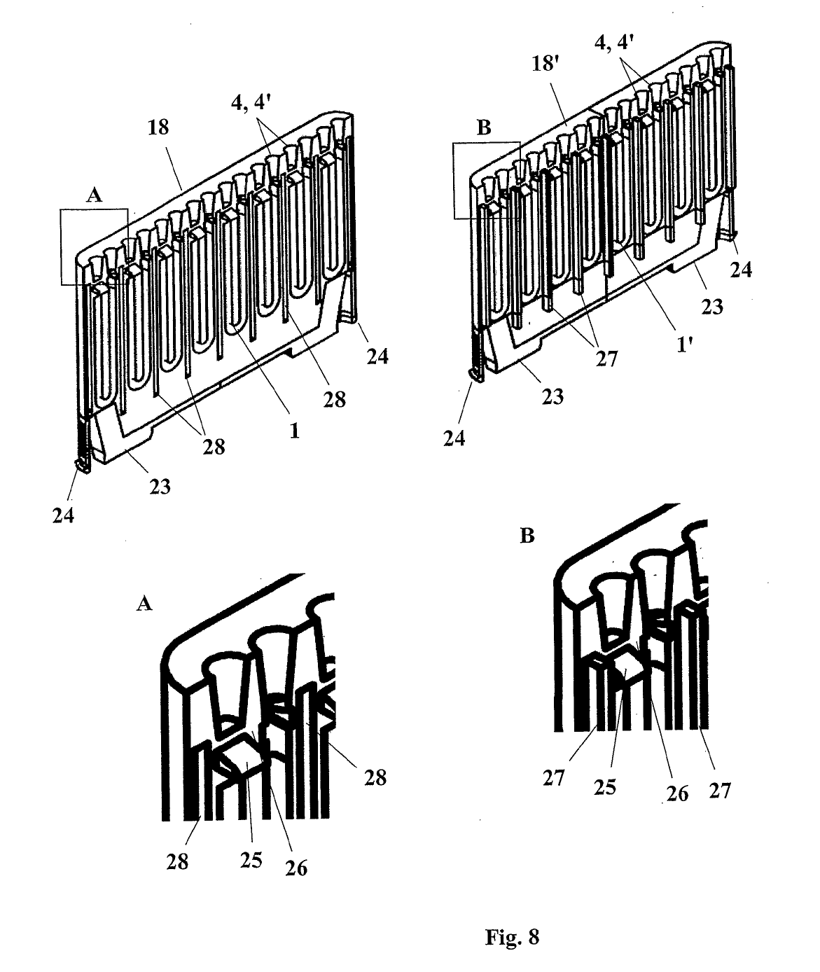

FIG. 7 illustrates a parallel assembly of plural 8-fold dialysis modules according to FIG. 6 on a carrier;

FIG. 8 illustrates a schematic view of the housing components (housing halves) of the 8-fold housing module according to FIG. 6;

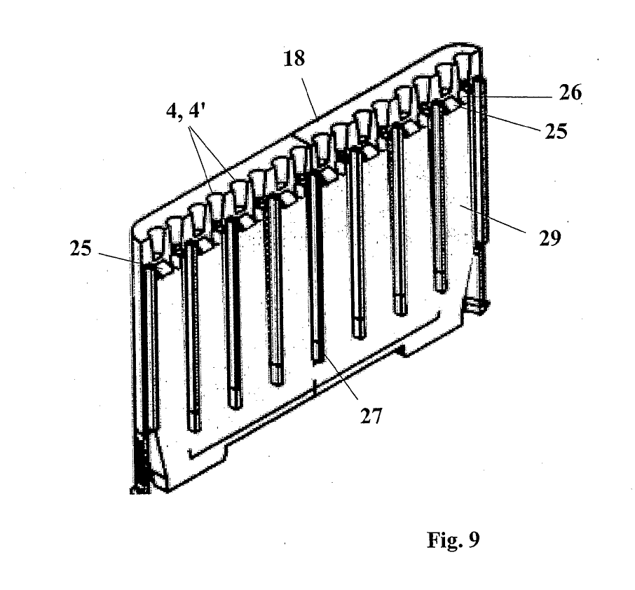

FIG. 9 illustrates a schematic view of a housing component of an 8-fold dialysis module according to FIG. 6 with an inserted comb shaped membrane and support and retaining elements for the membrane.

FIG. 1 schematically illustrates a pair of corresponding, opposed and aligned capillaries 1, 1′, with respective open ends which are connected through a semi permeable membrane 2. The capillary 1 is introduced as a substantially U-shaped recess in a plane of the housing component 3 and the capillary 1 is introduced as a substantially U-shaped recess in a plane of the housing component 3′. The recesses for the capillaries 1, 1′ can e.g. be created through milled recesses in the housing components 3, 3′ or directly through the production of the housing components 3, 3′, e.g. through injection molding. The open ends of the capillaries 1, 1′ are respectively run out in upward direction from the housing components 3, 3′ as openings for 4, 4′ for introducing and removing fluid which is not shown for reasons of clarity or as openings 5, 5′ for ventilation. The openings 4, 4′ are respectively configured jointly by the two housing components 3, 3′ and are configured conical for sealing relative to an exemplary pipette 6 element for introducing and/or removing, so that a lateral gas- or liquid seal between the conical opening surface of the opening 4 or 4′ and the also conically configured tip of the pipette element 6 is formed. The openings 5, 5′ for ventilation are respectively only formed by the respective housing components 3, 3′ and by the membrane 3, between the housing components 3, 3′.

In order to seal the capillaries 1, 1′ the membrane 3 with the edge portions of the capillaries 1, 1′ is tightly pressed on or connected. For sealing connection the pressure through which the housing components 3, 3′ are compressed and/or gluing with known glues or welding with known methods like ultrasound, high frequency and laser welding can be applied. Surfaces of the housing components 3, 3′ which contact outside of the inner membrane surface are also connected tight through pressure, gluing or welding.

As illustrated in FIGS. 2a-2f, the capillaries 1, 1′ can have different cross sectional shapes like rectangular, square, semi circular, circular segment shaped and triangular. Overall the capillary 1, 1′ thus extends essentially U-shaped as schematically illustrated in the portion which is used for sample analysis.

However within the substantial U-shape partial sections of the capillaries 1, 1′ which are relevant for dialysis can have a constant curvature or a non constant curvature or can be serrated e.g. bent or have a zigzag shape or can have a meander shape. Examples are schematically illustrated in FIG. 3

The maximum distance of the wall of the capillary 1, 1′ from the membrane 3 is less than 4.5 mm, preferably at the most 1.5 mm.

As illustrated in FIG. 1 the openings 4, 4′ into which known pipette elements 6 engage for introducing and removing are configured in upward direction in the housing components 3, 3′. The openings 4, 4′ include seal elements which are configured in FIG. 1 as described supra and also in FIG. 4a and FIG. 4d as substantially cone shaped configuration of the opening 4, 4′. The seal elements cause the recited sealing of the openings 4, 4′ relative to the pipette 6 and thus assure that a reliable sample loading or sample extraction is performed during the sample dispensing or extraction through expelling or suctioning the liquid in or out of the capillaries 1, 1′.

FIG. 4b and FIG. 4c illustrate additional seal elements which can be attached at or in the openings 4, 4′. FIG. 4b illustrates an elastic seal ring 7 which is supported in a respective semi circular recess 8 of the opening 4, 4′. In FIG. 4c there is a known seal mat 9 on the opening 4, 4′, wherein the seal mat respectively includes a prefabricated pass through opening 10 corresponding with the opening 4, 4′, wherein the pipette element 6 is run in an elastically sealing manner through the pass through opening 10 into the opening 4, 4′.

In order to keep the force for sealing introduction and extraction of the pipette element 6 (pipette tip or needle) small, the contact surfaces between the pipette element 6 and the seal elements should be kept as small as possible and the elastic seal material should have lithe hardness. It can be made e.g. from silicone rubber or from foamed elastomeric material. The material of the seal mat is a soft elastomeric like e.g. acrylnitril-butadien-caoutchouc, styrol-butadien-caoutchouc, chloroprene-caoutchouc, butadiene-caoutchouc, ethylene-propylene-dien-caoutchouc, natural rubber or foamed silicon rubber.

The other open end of the capillary 1, 1′, which is not used for loading, is also run in upward direction out of the housing components 3, 3′ as illustrated in FIG. 1 and also in FIG. 5a and terminates in the opening 5, 5′ for ventilation. This end of the capillary 1, 1′, however, as illustrated in FIG. 5b, can be run out outside of an essentially U-shaped portion 11 (portion of the capillaries 1, 1′ illustrated in lighter shade), which is relevant for dialysis, can be run out through a 180° curvature 12, 12′ in downward direction to an opening 13, 13′, through which the removal or also a ventilation can be performed. Through this 180° curvature 12, 12′, the capillary 1 or 1′ in addition to the U-shaped dialysis portion 11 overall essentially extends in an S-shape (cf. also FIG. 3b and FIG. 3d).

In FIG. 5a, the opening 4, 4′ is used for feeding the capillary 1, 1′ and also for extracting from it, which shall be represented by arrows 14, 15, which symbolize the liquid movement for feeding and extracting the capillary 1, 1′.

In FIG. 5b, the capillary 1, 1′ terminates with respect to the opening 4, 4′ in the opening 13, 13′, which is advantageously configured as an outlet protruding towards the housing base. Pressing air into the opening 4, 4′, e.g. also through the pipette element, can thus be used for sample dispensing into a micro-titer plate, which is disposed there under and not illustrated. The protruding outlet prevents the sample liquid from running along at the base of the vessel and prevents possible mixing with sample liquids of adjacent sample vessels. An arrow 16 shall indicate the direction of sample extraction in FIG. 5b.

FIG. 6 illustrates a bar shaped module 17, in which eight capillary units described in principle in FIG. 1 (eight pairs of respectively corresponding, opposed and aligned capillaries, which are respectively connected through a membrane and which are respectively open on both sides) are disposed adjacent to one another in a housing bar. The total of sixteen openings 4, 4,' for sample introduction and removal from the eight capillary units are run in upward direction and disposed in series in the grid of columns or rows of micro-titer plates according to ANSI SBS, wherein the openings 4, 4′ are respectively formed by both housing components 18, 18′ of the bar shaped module 17 (cf. also FIG. 8 and FIG. 9). The invention is not limited to the illustrated arrangement of eight capillary units. Thus, twelve or other numbers of capillary units can be integrated.

It is a substantial advantage of the bar shaped module 17 that the eight capillary units can be simultaneously filled and emptied through the openings 4, 4′ with known pipette systems of the liquid handling technique, which facilitates automating the dialysis in reference to preparation, execution and post processing.

The openings 5, 5′ for ventilation are run out laterally, and also disposed in series in a groove shaped recess 19. The ventilation gases can be run out in a downward direction in the groove shaped recess 19. The bar shaped module 17 furthermore includes designations 20 of the particular and adjacent capillary units, wherein the designations are used for orientation in the present embodiment letter embossing.

The bar shaped modules 17 additionally include support and attachment elements in the lower portion with which they are disposed on a support 21 and can be cascaded in parallel (cf. FIG. 7). The support 21 includes recesses 22, into which pedestal elements 23 and snap-in spring elements 24 engage as support and mounting elements during assembly.

With the support and attachment elements recited supra, the dialysis modules on the support 21 can be removably attached and assembled, preferably according to the standard dimensions of known micro-titer plates according to ANSI SBS. Also, an irreversible assembly, e.g. through welding or gluing, is conceivable.

The attached dialysis module(s) (bar-shaped modules 17) can thus be operated, transported and stored in a simple manner. The dialysis matrix assembled from the bar-shaped modules 17 preferably corresponds with respect to width and length with its openings 4, 4′ to the grid of micro-titer plates recited supra, so that a simultaneous loading and unloading of all capillaries 1, 1′ of the dialysis matrix is facilitated with conventional pipette systems, which are not illustrated.

Thus, also bar-shaped modules of capillary units according to FIG. 5b can be implemented, in which the openings 13, 13′ for extraction/venting are respectively configured in downward direction and also correspond to the recited grid. This way, dialysis matrices can be assembled, in which the samples can be simultaneously emptied into micro-titer plates, disposed under the dialysis matrix (not illustrated in detail in the drawing figure). In this context, it is advantageous for the dialysis matrix or the particular bar-shaped modules to have retaining and support elements for a coupling with a micro-titer plate of this type. This can be e.g. edge portions which facilitate placement onto the micro-titer plates.

Instead of the carrier 21, it is also conceivable to receive the bar-shaped modules 17 in a tub-shaped container, which is not illustrated and which can include supports and retaining elements itself for receiving and attaching the bar-shaped modules 17.

The base elements for the housing components 3, 3′ and 18, 18′ are made from plastic material. The housing components can also be produced by machining methods, and also through drawing or preferably through injection molding. Plastic materials like polypropylene, cyclic olefin polymer (e.g. topas), polyethylene, polycarbonate, polyurethane, silicon polymers, phenoplast, and polyester are suitable in particular. The housing components are connected inseparably and in a sealing manner, e.g. through gluing or welding to form a dialysis module (cf. FIG. 6) after inserting a semi-permeable membrane (cf. FIG. 1 and FIG. 9) with the desired connection size of 100 D to 2,000,000 D between both housing components 3, 3′ or 18, 18′. Suitable membrane materials are among others regenerated celluloses, cellulose acetate, polysulfonpolymer, polyethersulfonpolymer, polycarbonate, nitrocellulose or combined materials thereof.

The two housing components 18, 18′ have the gap format of micro-titer plates, and respectively include eight U-shaped capillary units (FIG. 8). Above the capillaries 1, 1′ in the housing components 18, 18′, there are sixteen conical openings 4, 4′, which are respectively formed in half by a housing component. Through the conical openings, the capillaries 1, 1′ disposed opposite to one another and separated from one another, respectively through a membrane (not shown in FIG. 8 for clarity, cf. however, FIG. 9) can be filled or emptied. Below the openings 4, 4′, there are as evident from the enlarged partial illustrations A and B in FIG. 8, support and retaining elements disposed adjacent to one another in each housing component 18 or 18′ in an alternating manner, configured as protrusions 25 and recesses 26, wherein each protrusion 25 of the housing component 18 respectively engages a corresponding fitted recess 26 of the housing component 18′ and vice versa when joining the housing components 18, 18′. The support and retaining elements are primarily used for joining the two housing components 18, 18′ and they also determine the sample path from the respective opening 4, 4′ into the respective capillary 1, 1′ and as a third function, the protrusions 25 are used as supports for inserting the membrane (cf. also FIG. 9).

The other end of the capillary 1, 1′ respectively terminates below the protrusion 25 for the embodiment in FIG. 8 and is respectively run perpendicular to the capillary 1, 1′ as a vent hole (not visible in the illustration) through the rear housing wall (cf. openings 5, 5′) in FIG. 6. Respective groove shaped recesses are disposed in the outer walls of the dialysis module (cf. groove shaped recess in FIG. 6), wherein the vent holes of the capillaries 1, 1′ terminate in the recesses.

As evident from FIG. 8, spring type bars 27 are configured between the capillary units in the housing component 18 and corresponding fitting grooves 28 are provided in the housing component 18′, wherein the grooves respectively engage one another when joining the housing components 18, 18′. The grooves 28 and spring type bars 27 which can be disposed in each housing component 18, 18′, also in an alternating manner besides one another between the capillary units (not illustrated), are used for support during the assembly of the housing components 18, 18′ and the membrane for sealing the capillary units relative to one another, and for connecting the housing components 18, 18′ as gluing or welding surfaces.

The capillary assembly facilitates achieving a high sample density of 2×96 sample volumes respectively separated from one another through a membrane. For a rectangular capillary cross section with a width of 2 mm and a depth of 1 mm, a ratio of membrane surface in mm² to sample volume in mm³ of one is reached. This is significantly more favorable than for the best known solutions. The ratio can be increased even further when a semicircular capillary cross section is selected or when the depth of the capillary 1; 1′ is reduced. The small depth simultaneously provides very short diffusion paths and thus reduces the necessity to shake the device, in order to thus mix the samples.

For the dialysis, the portion with the openings 4, 4′ can be closed entirely or partially through a cover or a glue foil (not illustrated in the drawing for reasons clarity) during equilibrium analysis in order to protect against contamination or evaporation.

FIG. 9 illustrates the housing component 18 with an inserted common cone shaped membrane 29 for all of the eight capillary units disposed adjacent to one another. For support, the membrane 29 contacts the protrusions 25 and the spring type bars 27.

Due to their configurations, the housing components illustrated in FIGS. 8 and 9 can be produced without interfering barriers for ejection from the injection molding machine in a simple and cost effective manner.

Through the configuration as bar-shaped modules 17 and their modular cascading as flat and automatically treatable dialysis modules, it is possible without problems to vary the number of samples and to define them as a function of the respective application.

All features recited in the description and in the embodiments and illustrated in the figures and recited in the claims can define the invention by themselves or in any combination with one another.

### REFERENCE NUMERALS AND DESIGNATIONS

1, 1′ capillary
2 membrane
3, 3′ housing component
4, 4′ opening for loading and possibly unloading
5, 5′ opening for ventilation
6 pipette element
7 seal ring
8 recess for seal ring 7
9 seal mat
10 pass-through opening of seal mat 9
11 U-shaped portion of capillaries 1, 1′
12, 12′ 180° turn
13, 13′ opening for unloading and/or ventilation
14, 15, 16 arrow
17 bar-shaped module
18, 18′ housing component
19 groove shaped recess
20 designation of capillary units
21 carrier
22 recess
23 pedestal element
24 spring element
25 protrusion configured as support and retaining element
26 groove shaped recess configured as support and retaining element
27 spring type bar
28 groove
29 comb-shaped membrane
30 outlet channel

1. A device for equilibrium dialysis of liquids with small volumes, comprising:
capillaries (1, 1′) corresponding and aligned opposite to one another, connected through a membrane (2, 29) and respectively open at both ends, wherein the capillaries respectively include an essentially U-shaped bent capillary portion in a vertical position (11) for performing the equilibrium dialysis and wherein the at least one opening of the capillaries is respectively provided with a seal element (7, 9) in an upper position (4, 4′) for reversible sealing relative to an inserted filling and/or extraction element (6) for introducing and/or removing the liquid.

2. The device according to claim 1, wherein the cross section of at least one capillary (1, 1′) is essentially square, rectangular, circular segment shaped or triangular.

3. The device according to claim 2, wherein the edges of the at least one capillary (1, 1′) are rounded or beveled.

4. The device according to claim 2, wherein a point of the capillary cross section that is the furthest remote from a membrane (2) in a perpendicular manner is not offset from the membrane (2) by more than 4 mm and the maximum width of the capillary (1, 1′) is ≦4 mm.

5. The device according to claim 2, wherein the cross sections of the corresponding opposed and aligned capillaries (1, 1′) is respectively equal or different.

6. The device according to claim 1, wherein the volume of the capillaries (1, 1′) is respectively less than 300 μl.

7. The device according to claim 1, wherein the maximum length of the capillaries (1, 1′) is 500 mm.

8. The device according to claim 1, wherein the capillaries (1, 1′) within the curved capillary portion (11) used for dialysis are additionally shaped in order to increase the dialysis portion and have a meander shaped, curved or zigzag shaped path.

9. The device according to claim 1, wherein the corresponding capillaries (1, 1′) are respectively preferably an integrated component of housing components (3, 3′, 18, 18′) which fit into one another and which can be joined by placing the membrane (2) there between.

10. The device according to claim 9, wherein the capillary (1, 1′) is respectively configured as a recess in the housing component (3, 3′, 18, 18′).

11. The device according to claim 9, wherein the housing components (3, 3′, 18, 18′) are made of metal, glass, plastic material, silicone, or silicone polymer.

12. The device according to claim 9, wherein the corresponding joinable housing components (3, 3′, 18, 18′) include joining and retaining elements (25, 26, 27, 28) and the joining and retaining elements (25, 26, 27, 28) simultaneously have a liquid- and gas sealing effect.

13. The device according to claim 12, wherein the joining and retaining elements (25, 26, 27, 28) are simultaneously used as conductor elements for ultrasound for ultrasound welding of the housing components (3, 3′, 18, 18′), so that the joining and retaining elements (25, 26, 27, 28) are welded or glued to one another in joined condition at the contact points of the housing components (3, 3′, 18, 18′) after ultrasound treatment.

14. The device according to claims 1 and claim 9, wherein the ends of the capillaries 1, 1′ are respectively run out in an upward direction as openings (4, 4′, 5, 5′) of the housing components (3, 3′, 18, 18′), wherein respectively at least one of the openings (4, 4′) is respectively used for introducing and removing the liquid and the openings (4, 4′) are respectively formed symmetrical from the housing components (3, 3′, 18, 18′).

15. The device according to claim 9, wherein the membrane (2, 29) is fixated with respect to its position by one or plural positioning elements (25, 27) provided at least at one housing component (3, 3′, 18, 18′) between the housing components (3, 3′, 18, 18′).

16. The device according to claim 9, wherein the membrane (2, 29) is attached between the housing components (3, 3′, 18, 18′) through gluing, welding, or clamping.

17. The device according to claim 9, wherein the housing components (3, 3′, 18, 18′) are connected with one another permanently and tied outside of the contact surfaces of the membrane (2, 29) through compressing, gluing or welding.

18. The device according to claim 1, wherein the membrane (2, 29) is semi permeable with a stop limit ≧100 D and ≦2,000,000 D.

19. The device according to claim 1, wherein the membrane (2, 29) is hydrophilic or hydrophobic and made from a polymer, a polymer combination or a ceramic material.

20. The device according to claim 9, wherein a number of eight or twelve pairs of respectively corresponding, opposed and aligned capillaries (1, 1′) are disposed adjacent to one another in a bar shaped module (17) including two housing components (18, 18′) with a membrane (29) disposed there between.

21. The device according to claims 9, wherein a single cone shaped membrane (29) is provided for all pairs of the respectively corresponding opposed and aligned capillaries (1, 1′) of the bar shaped module (17).

22. The device according to claims 9, wherein separate membranes are provided for the pairs of respectively corresponding, opposed and aligned capillaries (1, 1′) of a bar shaped module (17), wherein the membranes are respectively positioned in the bar shaped module (17) one by one.

23. The device according to claim 20, wherein the bar shaped module (17) has a width of ≦9 mm and a length of ≦120 mm and one or plural bar shaped modules (17) are attached with their lower portions in parallel behind one another in a mechanically disengageable or fixated manner on a base element, e.g. a carrier (21).

24. The device according to claim 20, wherein one or plural bar shaped modules (17) are received e.g. in a tub shaped container with their lower portions in parallel behind one another in a mechanically disengageable or fixated manner.

25. The device according to claim 20, wherein the housing components (18, 18′) of the bar shaped modules (17) include support and retaining elements (23) and spring elements (24) in their lower portions of the housing components.

26. The device according to claim 20, wherein all openings (4, 4′) for introducing and/or removing fluid of the pairs of respectively corresponding, opposed and aligned capillaries (1, 1′) of a bar shaped module (17) are run in upward direction and formed in series by both housing components (18, 18′).

27. The device according to claim 26, wherein the openings (4, 4′) respectively disposed in series are connected in sequence respectively in an alternating manner with a capillary (1, 1′) of the one or the other housing component (18, 18′) for introducing and/or removing the fluid.

28. The device according to claim 26, wherein the housing components (18, 18′) respectively include elements (25) under the openings (4, 4′) for introducing and/or removing the fluid, wherein the openings are configured for introducing liquid into the respective capillary (1, 1′) and for sealing relative to the corresponding capillary (1, 1′).

29. The device according to claim 28, wherein the elements (25) for liquid conduction are simultaneously configured as positioning-and retaining elements for the housing components (18, 18′) of the bar shaped module (17) and/or of the membrane (29).

30. The device according to claim 1, wherein the respective end of each capillary (1, 1′) opposed to the opening (4, 4′) for feeding and/or removing the liquid is disposed outside of the dialysis portion (11) as a vent opening (5, 5′) to the outside.

31. The device according to claims 20 and 30, wherein the vent openings (5, 5′) are respectively provided in the upper portion of the lateral outer surfaces of the housing components (18, 18′) of the bar shaped module (17).

32. The device according to claim 31, wherein the vent openings (5, 5′) for the purpose of air conduction are respectively disposed within a recess of the housing component (18, 18′).

33. The device according to claim 1, wherein the respective end of each capillary (1, 1′) opposed to the opening (4, 4′) for introducing the liquid is configured as an outlet channel (30) for removing the liquid and is run in downward direction outside of the dialysis portion (11) and/or configured as a venting channel.

34. The device according to claim 33, wherein the outlet channel (30) run in downward direction respectively terminates in an outlet element (13, 13′) protruding towards the base of the housing components (18, 18′), e.g. a protruding outlet tube.

35. The device according to one or plural of the claims 20 33, wherein the ends of the capillaries run out in upward direction in the bar shaped modules (17) and configured as openings (4, 4′) for loading and unloading are disposed according to the Standard ANSI/SBS 1-204 position compatible with the grid of micro-titer plates.

36. The device according to claim 1, wherein the at least one opening (4, 4′) for introducing and/or removing the liquid is configured entirely or partially through slanted surfaces, e.g. cone shaped and expands in particular for form locking with a pipette element (6) introduced into the opening (4, 4′) in upward direction like a funnel in order to provide the seal element, wherein the contact pressure of the pipette element (6) provides lateral gas and liquid sealing relative to the slanted surface of the opening (4, 4′).

37. The device according to claim 1, wherein the at least opening (4, 4′) for introducing and/or removing the liquid includes a receiver (8) for a seal element, e.g. a seal ring (7), wherein the contact pressure of a pipette element (6) introduced into the opening (4, 4′) provides a lateral gas and liquid seal with respect to the seal element (7).

38. The device according to claim 1, wherein a soft seal mat (9) with pass through openings (10) is provided as a seal element, wherein the seal mat (9) is attached at the at least one opening (4, 4′) for feeding and/or removing the liquid through welding, injection molding, gluing or clamping, wherein the contact pressure of a pipette tip inserted through the seal mat (9) into the opening (4, 4′) provides a lateral gas- and liquid seal at the seal mat (9).

39. The device according to claim 1, wherein at least one opening (4, 4′) for feeding and/or removing the liquid is circular and has a diameter of <5 mm.
